(19) United States
(12) Patent Application Publication
(10) Pub. No.: US 2011/0142386 A1
(43) Pub. Date: Jun. 16, 2011

(54) BEARING RING AND METHOD FOR COOLING A BEARING RING

(75) Inventor: Michael Flouros, Munchen (DE)

(73) Assignee: MTU AERO ENGINES GMBH, MUNCHEN (DE)

(21) Appl. No.: 13/057,194

(22) PCT Filed: Jul. 30, 2009
(86) PCT No.: PCT/DE09/01064

§ 371 Date: Feb. 2, 2011

(30) Foreign Application Priority Data
Aug. 2, 2008 (DE) 10 2008 036 196.8

(51) Int. Cl. F16C 37/00

(52) U.S. Cl. 384/321

(57) ABSTRACT

The present invention relates to a bearing race, which exhibits an inside facing a rotational bearing-race axis and an outside facing away from the rotational bearing-race axis, in which at least one cooling-medium channel is disposed at the outside of the bearing race, which exhibits a hydraulic diameter of at least 1 millimeter and a length of at least two spiral turns.

### CROSS-REFERENCE TO RELATED APPLICATIONS

The present application is a U.S. National Phase application submitted under 35 U.S.C. §371 of Patent Cooperation Treaty Application Serial No. PCT/DE2009/001064, filed Jul. 30, 2001, entitled BEARING RING AND METHOD FOR COOLING A BEARING RING, which application claims priority to German Application Serial No. 10 2008 036 196.8, filed Aug. 2, 2008, entitled LAGERRING UND VERFAHREN ZUM KÜHLEN EINES LAGERRINGS, the specifications of which are incorporated herein by reference.

### TECHNICAL FIELD

The present invention relates to a bearing race, as well as a method for cooling a bearing race.

### BACKGROUND

The term “bearing race” and “bearing ring” as used herein should be understood to have the same meaning, i.e., the two terms are interchangeable. Conventional bearing races are both lubricated and cooled by an oil mixture, in which the oil mixture (lubricating oil) is sprayed directly or indirectly onto the bearing or the rotating system of the bearing race. The lubricating oil used is very hot then, so that there is danger of carbonizing the lubricating oil and therefore obstructing the lubricating-oil supply. In addition, a large amount of lubricating oil is needed to cool the bearing race, during strenuous operation of the bearing race with the bearing, in order to be able to remove the heat which arises sufficiently fast. If the heat generated by the bearing is not cooled off fast enough, damage to the bearing races occurs. Fast removal of the lubricating oil additionally requires a large and expensive cooler for the cooling oil.

### SUMMARY

Hence the task of the present invention is to make it possible to create better and faster cooling for a bearing race.

This problem is addressed by a bearing race with the characteristics disclosed and claimed herein, as well as a method with the steps disclosed and claimed herein. Further favorable embodiments of the invention are disclosed and claimed herein

A first embodiment provides a bearing race which exhibits an inside facing a rotational bearing-race axis and an outside facing away from the rotational bearing-race axis, in which at least one cooling-medium channel is disposed at the outside of the bearing race and which exhibits a hydraulic diameter of at least 1 mm and a length of at least two spiral turns.

Furthermore, another embodiment provides a method for cooling a bearing race which exhibits an inside facing the rotational bearing-race axis and an outside facing away from the rotational bearing-race axis, in which at least one cooling-medium channel is disposed at the outside of the bearing race and in which the method exhibits the following steps:
supplying a cooling medium into the cooling-medium channel of the bearing race; and
removing the cooling medium from the cooling-medium channel of the bearing race.

The present embodiments are based on the approach that the cooling of the bearing race no longer takes place by direct or indirect injection of the lubricating oil onto the bearing, but that the cooling of the bearing race is possible, in essence, through a cooling medium which flows through the cooling-medium channel on the outside of the bearing race. With this approach, one avoids having the cooling medium introduced directly onto sliding or rubbing surfaces and additional parasitic losses arising. Rather, the heat-conduction property of the bearing-race material is used to advantage, and the heat arising during operation of the bearing is removed through the outside of the bearing race.

The present embodiments offer the advantage that lubricating oil with particularly good lubrication properties can be used, so that the amount of the lubricating oil can be reduced to a minimum, due to the more effective cooling effect. As a result, consider-ably less churning occurs, and the heat-to-oil ratio can be reduced by 30 to 40 percent. Due to the considerably larger surface on the outside of the bearing race as well as heat conduction through the bearing race, no such high oil temperature is expected to arise either, as happens with the direct or indirect injection of the lubricating oil onto the rotating system or parts thereof. Therefore the cooler for the lubricating oil can also be designed to be smaller, and the danger of carbonizing and fire can be lessened. On the whole, there also occurs thereby an increase in the service life of the moving parts of the bearing race.

Furthermore, these embodiments make the operation of the system as a damper (a squeeze-film damper) possible by means of the oil flow between the outer race and the housing.

It is beneficial if the cooling-medium channel on the outside is embedded in the material of the bearing race. This guarantees optimal heat transfer from the rubbing, sliding, or rotating parts of the bearing race to the cooling-medium channel, which is not disturbed by a glue or screw connection or similar.

According to a favorable embodiment of the invention, the cooling-medium channel can be disposed in a spiral shape around the outside of the bearing race. As a result, heat-absorption surfaces can be advantageously ensured to be as large as possible around a small bearing race, so that optimal heat removal is guaranteed.

In another embodiment of the invention, the outside of the bearing race can be disposed at an outer race and the inside of the bearing race at an inner race, in which the outer race is connected to the inner race by means of an anti-friction, roller, ball, or journal bearing. With bearing races constructed of many parts, it can also hereby be guaranteed that heat transfer is provided from the rotating elements to the outside with the cooling-medium channel. It is not material here which bearing shape (such as, for example, an anti-friction bearing, a roller bearing, a ball bearing, or a journal bearing, or similar) achieves the movement from the inner race to the outer race. Rather, the direct contact between the bearing and the cooling-medium channel will be guaranteed at the outside by the material of the outer race.

Also, the cooling-medium channel can exhibit a hydraulic diameter of at least 1 mm. This advantageously ensures that the diameter of the cooling-medium channel is large enough that, on the one hand, too great a flow resistance does not build up, and on the other hand too, it is not immediately obstructed by the appearance of small particles in the cooling medium or the cooling oil.

In particular, the cooling-medium channel can exhibit an overall length at the outside of the bearing race which corresponds to at least eight times the diameter of the bearing race or the hub of a inner bearing of the bearing race. Such an embodiment of the present invention has the advantage that the cooling medium (cooling oil) does not stay too short a time in the cooling-medium channel for effective heat transfer from the walls of the cooling-medium channel to the cooling medium to be able to take place.

In another embodiment of the invention, the cooling-medium channel exhibits an overall length at the outside of the bearing race which corresponds at most to 20 times the diameter of the bearing race. This advantageously ensures that the cooling medium is not heated up too much, so that, in using oil as a cooling medium, it might also lead to carbonizing and therewith to obstruction of the cooling-medium channel. Also, in using cooling-medium channels of maximum length, it can be ensured that only small cooling-medium coolers have to be provided.

In a further embodiment of the present invention, the bearing race can exhibit a lubricating-oil channel to conduct the cooling medium onto the bearing, in which the lubricating-oil channel is sealed fluid-tight compared with the cooling-medium channel. This makes possible the complication-free use of separate lubricating and cooling media, so that optimal adjustment of each of the required properties, specifically the lubricating and cooling properties, can be individually adjusted. In this case, there must be no compromise entertained between cooling and lubricating properties of the oil. In addition, minimizing is also hereby ensured in the lubricating oil needed, which can then be selected to be temperature-constant, compared with high bearing-race temperatures.

A bearing device can also be provided which includes a fuel tank to supply an engine with fuel, as well as a bearing race as has been described above, in which the cooling-medium channel is connected to the fuel tank such that the fuel can flow through the cooling channel. Such a bearing device offers the advantage that the fuel is also used as a cooling medium, as a result of which a separate cooling-medium circulation system is no longer provided. Heating the fuel can also take place by means of such a bearing device, which may be needed for a favorable flow property during high-altitude flight or in the cold or to improve the adjustment/adaptation of emission values.

### BRIEF DESCRIPTION OF THE DRAWINGS

The invention is clarified in detail below, with the aid of the drawings enclosed by way of example. Shown are:

FIG. 1 is a three-dimensional representation of an example embodiment of the present invention;

FIG. 2 is a sectional representation of a further example embodiment of the present invention;

FIG. 3 is a side view of an example embodiment of the present invention; and

FIG. 4 is a block diagram of an example embodiment of the present invention as a method.

### DETAILED DESCRIPTION AND EMBODIMENTS OF THE INVENTION

Possible dimensions and sizes are only given as examples, so that the invention is not limited to these dimensions and sizes. Identical or similar elements might be provided with identical or similar reference numbers, in which a repeat description of these elements is omitted. Furthermore, the drawings of the figures, their description, and the claims contain numerous characteristics in combination. It is clear then to a person knowledgeable in the art that these characteristics can also be considered individually or can be further combined for combinations not explicitly described here.

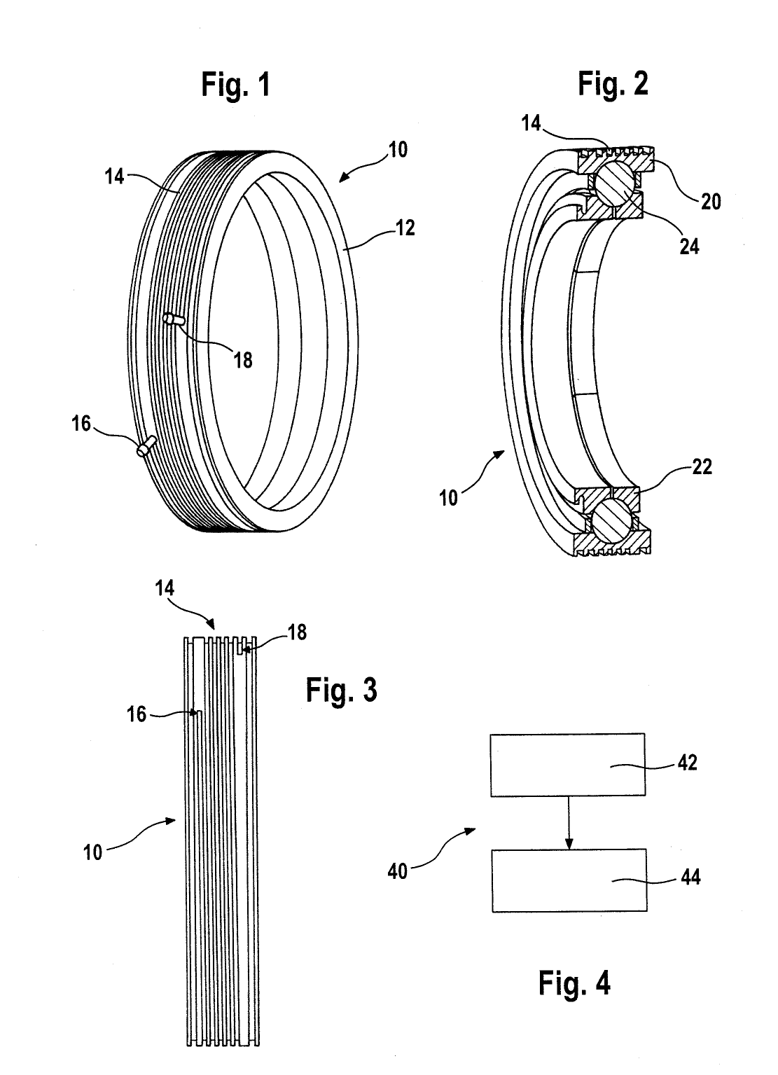

FIG. 1 shows a three-dimensional representation of a first embodiment example of the present invention. The three-dimensional representation shows an outer part 12 of a bearing race 10 in which a cooling-medium channel 14 is disposed in this outer part 12 forming a spiral. The three-dimensional representation in FIG. 1 here shows the cooling-medium channel 14 in an open, that is, an uncovered, mode. To a person knowledgeable in the art, it is obvious here that, for the operation of the bearing race 10 represented, the at least one cooling-medium channel 14 is covered, whereby the cooling medium cannot run out of the cooling-medium channel 14. In addition, a cooling-medium inlet 16 is represented in FIG. 1, through which a cooling medium can be conducted to the cooling-medium channel 14. The cooling medium then flows through the cooling-medium channel 14 disposed in a spiral shape and is supplied to the cooling-medium outlet 18.

FIG. 2 shows a sectional representation through a bearing race 10 according to a further embodiment example of the present invention. In this embodiment example, the bearing race 10 contains an outer part 20 as well as an inner part 22, which are connected to one another by means of a ball bearing 24. The inner part 22 is disposed up to a rotational axis of the bearing race 10 and can, for example, be fastened to a rotatable hub of a machine element not depicted in FIG. 2. For rotatable seating between the outer part 20 and the inner part 22, further bearing shapes, such as an anti-friction bearing, a roller bearing, a journal bearing, or similar can also be used, in which the bearing shape has no material effect on the functionality of the invention.

FIG. 3 shows a side view of an embodiment example of the bearing race 10 according to the invention. Here, the cooling-medium channel 14 is clearly apparent embedded in the material of the outside of the bearing race 10, which on the one hand offers good tightness and on the other hand the opportunity for very good heat transfer. Furthermore, the cooling-medium inlet 16 and the cooling-medium outlet 18 are also represented in FIG. 3. Alternatively, several smaller cooling-medium channels 14 can also be provided around the outside of the bearing race 10. It is beneficial if the cooling-medium inlet 16 and the cooling-medium outlet 18 lie as close as possible to one another (for example, are set, relative to the rotational axis, no more than 45° from one another), whereby problem-free movement of the connecting lines is possible at no great expense.

If the bearing race 10 is only operated with a rotatable shaft, then heat arises in the bearing 24 due to rolling or sliding friction, which is conducted by the material of the outer part 20 to the cooling-medium channel 14 disposed at the outside of the bearing race 10. The cooling medium flowing through the cooling-medium channel 14 absorbs this heat at the outside of the bearing race 10 and removes it, so that cooling of the bearing race 10 is thereby achieved. At the same time, a separation between lubricating medium and cooling medium can be obtained, so that optimization of the lubricating medium relating to good sliding properties and optimization of the cooling medium relating to good thermal properties are possible. Compromise, such as in the use of a combined lubricating-cooling medium must in this case no longer be entertained. In order for the lubricating or cooling medium to be kept separate from one another insofar as possible, the cooling-medium channel 14 should be sealed as fluid-tight as possible against the parts that are movably mounted.

A fuel can also be used as a cooling medium, for example for a engine (for an aircraft, for instance), so that by additionally using the already existing fuel circulation for cooling purposes, simplifications in the construction result due to omitting the cooling circulation. At the same time, heating the fuel (for instance by flying through cold layers of air) achieves favorable combustion properties in the combustion of the fuel in the engine, so that favorable emission values result for the engine.

Outer-race cooling consequently exists in the embodiment example illustrated above, in which oil flows out of the engine tank, specifically out of a spiral channel. The merit of the interpretation philosophy consists of heat being effectively removed in the outer bearing race. The channel geometry should be sized so that the criteria will be met for as great a tightness as possible, a large heat-transfer surface, and as small a pressure loss as possible. These criteria can be achieved using the following guidelines for the (hydraulic) diameter of the cooling-medium channel and the length of the spiral channel:
at least 1.0 millimeter for the (hydraulic) diameter of the cooling-medium channel, and
at least two spiral turns in length.

FIG. 4 shows a flow diagram of an embodiment example of the present invention as a method. The method 40 for cooling a bearing race which exhibits an inside facing a rotational bearing-race axis and an outside facing away from the rotational bearing-race axis, in which at least one cooling-medium channel is disposed at the outside of the bearing race, exhibits a first step 42 of supplying a cooling medium into the cooling-medium channel of the bearing race. In a second step 44, removal of the cooling medium from the cooling-medium channel of the bearing race takes place.

1-6. (canceled)

7. A bearing race including a ring-shaped outer race connected to a ring-shaped inner race by means of a plurality of anti-friction bearings disposed therebetween, the outer race having an outside surface facing away from a rotational bearing-race axis and the inner race having an inside surface facing toward the rotational bearing-race axis, the bearing race comprising:
at least one cooling-medium channel formed on the outside surface of the bearing race and embedded into the material of the bearing race;
the cooling-medium channel being disposed in a spiral shape around the outside surface of the bearing race;
wherein the cooling-medium channel has a hydraulic diameter of at least 1 mm; and
wherein the cooling-medium channel has an overall length at the outside of the bearing race of at least two spiral turns.

8. A bearing race according to claim 7, wherein the cooling-medium channel has an overall length that is at least eight times the outside diameter of the bearing race.

9. A bearing race according to claim 7, wherein the cooling-medium channel has an overall length that is not greater than twenty times the outside diameter of the bearing race.

10. A bearing race according to claim 7, wherein the bearing race further includes:
a lubricating-medium channel for feeding a lubricating medium onto the anti-friction bearings; and
wherein the lubricating-medium channel is sealed fluid-tight with respect to the cooling-medium channel.

11. A bearing device using engine fuel for cooling a bearing, the bearing device comprising:
a fuel tank for supplying an engine with fuel;
a bearing race including a ring-shaped outer race connected to a ring-shaped inner race by means of a plurality of anti-friction bearings disposed therebetween, the outer race having an outside surface facing away from a rotational bearing-race axis and the inner race having an inside surface facing toward the rotational bearing-race axis, the bearing race having at least one cooling-medium channel formed on the outside surface of the bearing race and embedded into the material of the bearing race, and the cooling-medium channel being disposed in a spiral shape around the outside surface of the bearing race;
wherein the cooling medium channel is connected to the fuel tank such that the fuel can flow through the cooling-medium channel.

12. A bearing device in accordance with claim 11, wherein the cooling-medium channel has a hydraulic diameter of at least 1 mm.

13. A bearing device in accordance with claim 12, wherein the cooling-medium channel has an overall length at the outside of the bearing race of at least two spiral turns.

14. A bearing device in accordance with claim 11, wherein the bearing race further includes:
a lubricating-medium channel for feeding a lubricating medium onto the anti-friction bearings; and
wherein the lubricating-medium channel is sealed fluid-tight with respect to the cooling-medium channel.

15. A method for cooling a bearing race including a ring-shaped outer race connected to a ring-shaped inner race by means of a plurality of anti-friction bearings disposed therebetween, the outer race having an outside surface facing away from a rotational bearing-race axis and the inner race having an inside surface facing toward the rotational bearing-race axis, the cooling method comprising the following steps:
providing least one cooling-medium channel disposed on the outside surface of the bearing race;
supplying a cooling medium into a cooling-medium inlet of the cooling-medium channel;
flowing the cooling medium through the cooling-medium channel from the cooling-medium inlet to a cooling-medium outlet; and
removing the cooling medium from the cooling-medium outlet of the cooling-medium channel.

16. A method in accordance with claim 15, wherein the cooling-medium channel of the bearing race has a hydraulic diameter of at least 1 millimeter and a length of at least two spiral turns.

17. A method in accordance with claim 15, further comprising the following steps:
providing a fuel tank for supplying an engine with fuel; and
flowing fuel from the fuel tank through the cooling-medium channel of the bearing race as the cooling medium.

18. A method in accordance with claim 17, further comprising the following steps:
providing a lubricating-medium channel for feeding a lubricating medium onto the anti-friction bearings, wherein the lubricating-medium channel is sealed fluid-tight with respect to the cooling-medium channel; and
flowing a lubricating medium that is separate from the fuel from the fuel tank through the lubricating-medium channel onto the anti-friction bearings.

19. A method in accordance with claim 15, further comprising the following step:
using the cooling medium in the area of the cooling-medium channel for hydraulic (squeeze-film) bearing damping.
